(19) United States
(12) Patent Application Publication
(10) Pub. No.: US 2023/0322367 A1
(43) Pub. Date: Oct. 12, 2023

(54) Monocopter

(71) Applicant: Category, LLC, Largo, FL (US)

(72) Inventor: Maurycy Sokolowski, Largo, FL (US)

(73) Assignee: Category, LLC, Largo, FL (US)

(21) Appl. No.: 17/717,643

(22) Filed: Apr. 11, 2022

(51) Int. Cl. B64C 39/02; B64C 27/00

(52) U.S. Cl. CPC B64C 39/024; B64C 2201/146; B64C 27/00

(57) ABSTRACT

A monocopter includes a housing and a propeller connected to a shaft. The shaft is connected to a main motor that is fixed to the housing (e.g., mounted within the housing) such that upon operation of the main motor, the shaft rotates and the propeller rotates. A first counterweight is interfaced to a shaft of a first motor that is interfaced to the housing and a second counterweight is interfaced to a shaft of a second motor that is also interfaced to the housing such that the shaft of the first motor is in a plane that is perpendicular to the shaft of the second motor (e.g., the shafts are at right angles to each other). The main motor, the first motor and the second motor are controlled (e.g., using artificial intelligence) to enable stable flight of the monocopter.

### BACKGROUND

Various types of aircraft have been developed and used since the first successful flight by Orville and Wilbur Wright in 1903. Most flight by air involves creating airflow at sufficient velocity as to move a payload (e.g., passengers) through the air. Some aircraft use jet engines or propellers driven by an engine to create thrust (air flow) to push an aircraft having wings through the air, creating lift as the flow of air over the top of the wing is faster than the air flow of air over the bottom of the wings.

In contrast, helicopters us a large propeller that is mounted horizontally and rotated by an engine, creating sufficient downward airflow to lift the payload. Helicopters require a second, smaller propeller and motor (or linkage to the first motor) to keep the payload from spinning once the helicopter is in the air. To maintain stability utilizing a reasonably sized and powered second propeller, the second propeller is positioned a large distance from the center of the large propeller. For horizontal movement, the helicopter tilts slightly to direct the thrust slightly off perpendicular, thereby pushing the helicopter in the intended direction.

Recently, battery operated drones have been introduced. These devices have multiple propellers (e.g., 3-6 propellers) oriented horizontally as the main propeller of the helicopter and each propeller is rotated by independent battery powered motors. An internal processor controls each motor to rotated the propellers at independent speeds, providing for control of lift (faster/slower), tilt (some motors rotate faster than others), and horizontal movement while tilted. Many drones include an internal global positioning receiver to determine location as well as gyroscope functionality to determine tilt and altimeter to determine altitude. In general, personal drones are controlled by a user's smartphone, sending signals to the drones over a wireless data channel. These drones are typically battery powered.

Although battery technology has improved since lead-acid and other sealed batteries as used in the 1900s. Newer battery technology provides for much higher energy/weight ratios and reasonable charging time. Still, most existing drones do not carry weight in addition to the electronic components, plastic housing, motors, and batteries, and are typically used for overhead photography.

When considering designing a drone to carry a payload, motor/propeller capability must be sufficient to carry the payload and, therefore, battery capacity must be increased as several motors running to rotate larger propellers at faster rates require more power. Although modern motors are very efficient, each motor has power losses. The wind power output of each motor/propeller is less than the power provided to the motor. These loses in power include heat generated from the resistance of the coils of the motor, friction of bearings at each end of the motor, and air friction on the propellers as the propellers move through air as evident from the noise that is generated. Having four or six motors multiplies this loss by four or six and further increases the weight of the system by four or six times the weight of each motor, wires, and structure. Therefore, it would be more efficient to utilize less motors, for example, one or two, but a flying device having only one or two propellers would not be stable and could not be controlled to move in a desired direction.

A helicopter accomplishes reduction in motor count, somewhat, having a single main engine that could be replaced by an electric motor, but the helicopter design still requires the second vertical propeller mounted a distance from the center of rotation of the main propeller, adding weight for the boom and consuming battery power to operate.

What is needed is a flying device having a single efficient motor/propeller that in which stability is maintained by shifting counterweights and such shifting requires minimal power consumption.

### SUMMARY

A monocopter is disclosed having a single propeller oriented horizontally and driven by a motor or engine at sufficient speed as to lift the monocopter, a power source for the motor or engine, and any associated load. To accomplish stability and to control direction of movement, two or more counterweights operating in different vertical planes are relocated to change the vertical orientation of the monocopter, thereby changing the direction of thrust of the single propeller and impacting horizontal movement of the monocopter.

A monocopter is disclosed including a housing and a propeller connected to a shaft. The shaft is connected to a main motor that is fixed to the housing (e.g., mounted within the housing) such that upon operation of the main motor, the shaft rotates and the propeller rotates. A first counterweight is interfaced to a shaft of a first motor that is interfaced to the housing and a second counterweight is interfaced to a shaft of a second motor that is also interfaced to the housing such that the shaft of the first motor is in a plane that is perpendicular to the shaft of the second motor (e.g., the shafts are at right angles to each other). The main motor, the first motor and the second motor are controlled (e.g., using artificial intelligence) to enable stable flight of the monocopter.

In another embodiment, a method of controlling a monocopter is disclosed including receiving command inputs and reading sensor data to determine at least a pitch of the monocopter, then calculating changes to the pitch of the monocopter required to follow the command inputs by inputting the sensor data and command inputs into an artificial intelligence engine, then adjusting two counterweights based upon an output of the artificial intelligence engine.

In another embodiment, a monocopter is disclosed including a housing and a propeller that is connected to a shaft. The shaft is connected to a main motor that is fixed to the housing such that upon operation of the main motor, the shaft rotates and the propeller rotates. There are at least two counterweights movably interfaced to the housing and a mechanism that independently moves each of the at least two counterweights for adjusting balance of the monocopter. The main motor and the at least two counterweights are controlled by a software system (e.g., an artificial intelligence engine) to enable stable flight of the monocopter.

Although the monocopter is well suited for carrying a payload, that being physical cargo, a person, or a camera, the monocopter is also capable of having sharp edges. As there are few moving parts and low power requirements, the monocopter is capable of being made in very small sizes (e.g., a few centimeters high) and is anticipated to have the ability to carry small cutting payloads such as razor blades, for example for cutting fruit from trees or vines. A swarm of such monocopters are anticipated due to ability to produce in a small size and low cost. Such miniature monocopters will have the ability to penetrate small openings, for instance and opening for air-intake on vehicle or a slightly ajar window.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a monocopter.

FIG. 2 illustrates an electrical schematic of a monocopter.

FIG. 3 illustrates a block diagram of a typical smartphone as used in some embodiments to control the monocopter.

FIG. 4 illustrates a learning model of the monocopter.

FIG. 5 illustrates a usage model of the monocopter.

FIG. 6 illustrates an exemplary learning system for the monocopter.

FIG. 7 illustrates a simplified software flowchart showing how the disclosed system operates based upon a single operation of liftoff.

### DETAILED DESCRIPTION

Reference will now be made in detail to the presently preferred embodiments of the invention, examples of which are illustrated in the accompanying drawings. Throughout the following detailed description, the same reference numerals refer to the same elements in all figures.

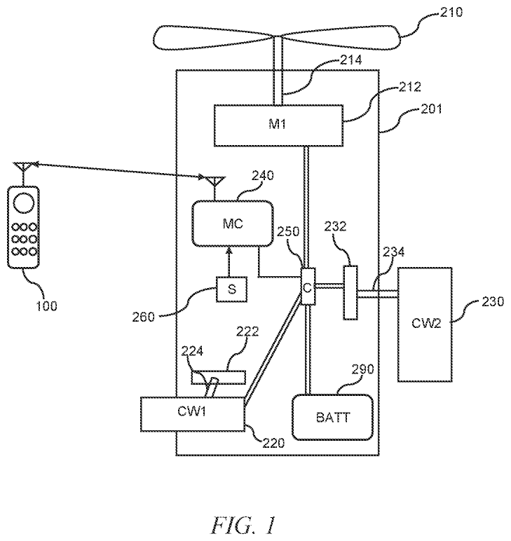

The monocopter 200 provides lift by way of a rotating propeller 210 that is driven by a rotational source of power. To maintain in-flight stability and enable horizontal directional changes, two or more counterweights 222/232 or movable ballasts are controlled to shift a center of balance of the monocopter 200. In the examples shown the rotational source of power is a main motor 212 (e.g., an electric motor) as shown in FIG. 1, though any type of lift generating source of power is anticipated including, but not limited to, fossil-fuel engines and jet engines. Also, in the examples shown, the two or more counterweights 220/230 are moved using electric motors 222/232, though any mechanism that moves the counterweights 220/230 is anticipates such as electro magnets and pneumatic pressure.

Initially, the monocopter 200 attains stable flight after trying several configurations of counterweights 220/230 and speed of the propeller 210 in actual flight, using random combinations of propeller speed and counterweight 220/230 positions in an attempt to move from point A to B, seek a solution to this movement as a method of learning. Learning will occur be setting an initial configuration of propeller speed and counterweight 220/230 position, then in a loop, reading the sensors 260, comparing with the goal (e.g., reach point B), adjusting the propeller speed and counterweight 220/230 positions, and repeating until stable flight is achieved and the monocopter 200 is able to move from point A to point B. Once learning is complete, the monocopter 200 will have the ability to reconfigure to a new solution should a component fail, for example, if one of the motors 222/232 fail.

Throughout this description, a smartphone 100 is used as an example of a device that provides control and processing power to the monocopter 200, though any electronic device, typically a processor-based device, is anticipated such as a mobile device having a transceiver, a storage medium and a human user interface. It is anticipated that, in some embodiments, the smartphone 100 would also incorporate one or more sensor circuits all of which provide inputs that are used by the disclosed software system and methods to provide location of the monocopter 200, altitude of the monocopter 200, pitch of the monocopter 200, speed of the monocopter 200, etc.

In FIG. 1, monocopter 200 is shown. The monocopter 200 includes a housing 201 for containing various components therein. Housed within the housing is a battery 290 for providing power to the monocopter 200. Although any battery 290 is anticipated, in some embodiments, the battery 290 is rechargeable.

For vertical lift and horizontal travel, a propeller 210 is connected to a shaft and rotationally coupled to a main motor 212 (or engine). As the propeller 210 is rotated at variable speeds by the main motor 212 by the main motor 212 that is coupled to the propeller 210 by a main shaft 214, the monocopter 200 lifts off of a surface on which it is located. The main motor 212 is controlled through a control circuit 250 by a microcontroller 240 or any processing element or equivalent logic. As such, the microcontroller 240 controls the amount of electric current flowing from the battery 290 to the main motor 212, thereby controlling a speed of rotation of the propeller 210 and, therefore, the amount of vertical thrust.

As it is assumed that the monocopter 200 is not perfectly balanced and even if it were, outside forces such as wind would cause instability in the flight of the monocopter 200, a balancing system is provided comprising two or more counterweights 220/230. As the monocopter 200 lifts from the surface, imbalances are detected by sensors 260 and the counterweights 220/230 are shifted to balance the monocopter 200 and provide vertical lift. The horizontal movement of the monocopter 200 is controlled by the same counterweights 220/230, shifting the balance of the monocopter 200 slightly off center such that the propeller 210 is askew of being level and, therefore, some of the thrust from the propellers 210 provide horizontal movement.

Although it is anticipated that the counterweights 220/230 be shifted by various mechanisms including electromagnetic force and pneumatic pressure, in the example shown in FIG. 1, each counterweight 220/230 is repositioned by being coupled to respective motors 222/232 though shafts 224/234 that are interfaced to the respective counterweight 220/230 in an offset location of the counterweight 220/230 (e.g., away from a center of gravity of each counterweight 220/230). Therefore, the motors 222/232 adjust the balance of the monocopter 200 through rotations of the counterweight(s) 220/230. To provide proper balance capability, the counterweights 220/230 rotate in planes that are preferably at right angles to each other along an imaginary axis of the main shaft 214. Therefore, rotation of the motors 222/232 rotate the counterweights 220/230 to change the balance of the monocopter 200. Note that the motors 222/232 need only be energized when a change is needed to the balance of the monocopter 200, either to stabilize the monocopter 200 or to slightly tile the monocopter 200 to force horizontal movement. In such, it is anticipated that the motors 222/232 are powered only intermittently when repositioning of the counterweigh 220/230 is needed and, therefore, require minimum power from the battery 290.

The counterweights 222/232 are controlled by the control circuit 250 under control of the microcontroller 240.

Although any motors 222/232 are anticipated, in some embodiments, the motors 222/232 are servo motors that maintain their rotational angles until controlled by the microcontroller 240 to change one or both rotational angles.

Also shown in FIG. 1 is a smartphone 100 that is communicatively coupled to the microcontroller by a wireless transmission arrangement such as Wi-Fi, Bluetooth, or any known or future wireless protocol over any licensed or unlicensed radio band (or visible light). As will be discussed, so that minimal power is consumed by the microcontroller 240, sensor data is transmitted to the smartphone 100 and much of the advanced calculations are performed by the smartphone 100, transmitting control information (e.g., power to the main motor 212 and intermittent power to either of the motors 222/232), thereby controlling thrust and an angle of the imaginary axis of the main shaft 214 with respect to level (a line or plane is level if it cuts all plumb lines that it meets at a right angle).

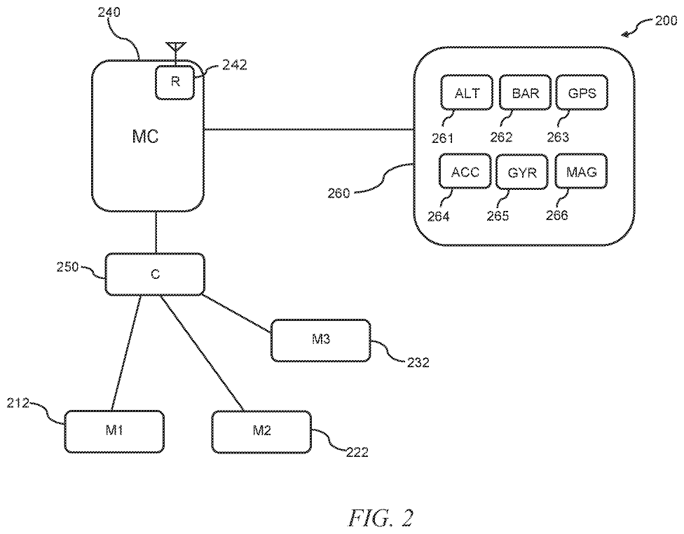

Referring to FIG. 2, an electrical schematic of a monocopter 200 is shown. The heart of the monocopter 200 is a microcontroller 240 that has wireless connectivity to the smartphone 100 by way of a transceiver 242 such as a Wi-Fi transceiver, Bluetooth transceiver or any type and power of transceiver that will exchange data between the monocopter 200 and the smartphone 100.

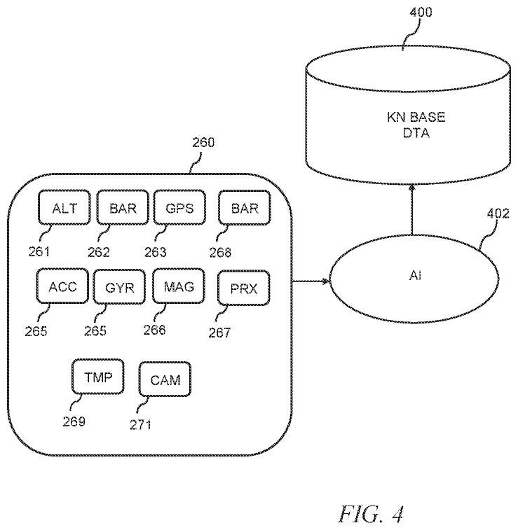

Connected to the microcontroller 240 is an array of sensors 260 that provide data to the microcontroller 240 as to location, angle, speed, altitude, etc. In this example, there are six sensors shown, an altimeter 261, a barometric sensor 262 (e.g., for sensing altitude), a global positioning sensor 263, one or more accelerometers 264, a gyroscope sensor 265, a magnetic sensor 266, a proximity sensor 267, a battery sensor 268 (e.g. senses remaining power), a temperature sensor 269, and a camera sensor 271; though any sensor that provides data important to the stability and movement of the monocopter 200 is equally anticipated as per the example shown in FIG. 4. As will be discussed, the microcontroller 240 analyzes data from the sensors 260 for making real-time adjustments to power delivered to each of the main motor 212 and the motors 222/232. As power consumption by the microcontroller 240 is important, some of the analysis, especially the analysis that utilizes artificial intelligence, is offloaded to the smartphone 100. In this some or all of the data from the sensors 260 is periodically transmitted by way to the transceiver 242 to the smartphone 100 where the data is further analyzed, resulting in the smartphone 100 transmitting updated settings to the microcontroller 240 by way of the transceiver 242.

Responsive to the local analysis or instructions received from the smartphone 100, the microcontroller 240 instructs the control circuit 250 to vary power provided to the main motor 212 (e.g., increase or decrease altitude/speed) or to either of the motors 222/232 to change the balance of the monocopter 200 and, hence, stabilizing the monocopter 200 or adjusting an angle of the monocopter 200 for horizontal motion. For example, if the sensors 260 report that the monocopter 200 is at an angle that is not totally vertical, then the microcontroller 240 signals the control circuit 250 to energize one or both of the motors 222/232 to change the weight distribution and correct the skew.

Details of the control circuit 250 are not provided for clarity and brevity reasons as controlling motors from outputs of a microcontroller or processor is well known in the art using, for example, power transistors or power FETs.

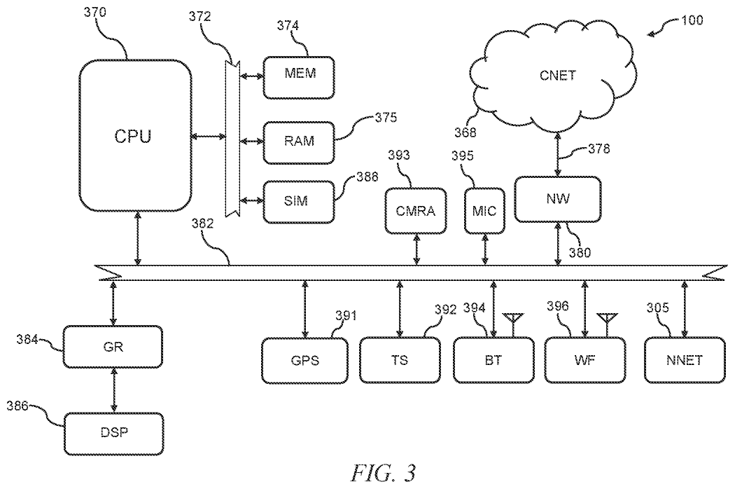

Referring to FIG. 3, a schematic view of a typical smartphone 100, is shown. Although any device(s) is/are anticipated, for clarity purposes, a smartphone 100 will be used in the remainder of the description.

The smartphone 100 shown represents a typical device one which some or all of the programming of the monocopter 200 operates. This exemplary smartphone 100 is shown in its simplest form. Different architectures are known that accomplish similar results in a similar fashion and the present invention is not limited in any way to any particular smartphone 100 system architecture or implementation. In this exemplary smartphone 100, a processor 370 executes or runs programs loaded in a random-access memory 375. The programs are generally stored in persistent memory 374 and loaded into the random-access memory 375 when needed. Also, accessible by the processor 370 is a SIM card 388 (subscriber information module) having subscriber identification encoded there within and often a small amount of persistent storage. The processor 370 is any processor, typically a processor designed for smartphones 100. The persistent memory 374, random-access memory 375, and SIM card 388 are connected to the processor by, for example, a memory bus 372. The random-access memory 375 is any memory suitable for connection and operation with the processor 370, such as SRAM, DRAM, SDRAM, RDRAM, DDR, DDR-2, etc. The persistent memory 374 is any type, configuration, capacity of memory suitable for persistently storing data, for example, flash memory, read only memory, battery-backed memory, etc. In some smartphones 100, the persistent memory 374 is removable, in the form of a memory card of appropriate format such as SD (secure digital) cards, micro-SD cards, compact flash, etc.

Also connected to the processor 370 is a system bus 382 for connecting to peripheral subsystems such as a cellular network interface 380, a graphics adapter 384 and a touch screen interface 392. The graphics adapter 384 receives commands from the processor 370 and controls what is depicted on the display 386. The touch screen interface 392 provides navigation and selection features.

In general, some portion of the persistent memory 374 and/or the SIM card 388 is used to store programs, executable code, and data, etc. In some embodiments, other data is stored in the persistent memory 374 such as audio files, video files, text messages, etc.

The peripherals are examples and other devices are known in the industry such as Global Positioning Subsystem 391, speakers, USB interfaces, cameras 393 (front and back facing), microphone 395, Bluetooth transceiver 394, Wi-Fi transceiver 396, etc., and including any sensor that aids in the navigation of the monocopter 200.

The cellular network interface 380 connects the smartphone 100 to the cellular network 368 through any cellular band and cellular protocol such as GSM, TDMA, LTE, etc., through a wireless medium 378. There is no limitation on the type of cellular connection used. The cellular network interface 380 provides voice call, data, messaging services as well as Internet access to the smartphone 100 through the cellular network 68.

For local communications, many smartphones 100 include a Bluetooth transceiver 94, a Wi-Fi transceiver 96, or both and some cell phones support other network schemes as well. Such features of smartphones 100 provide data communications between the smartphone 100 and data access points and/or other computers such as a personal computer (not shown) as well as a data connection to the monocopter 200.

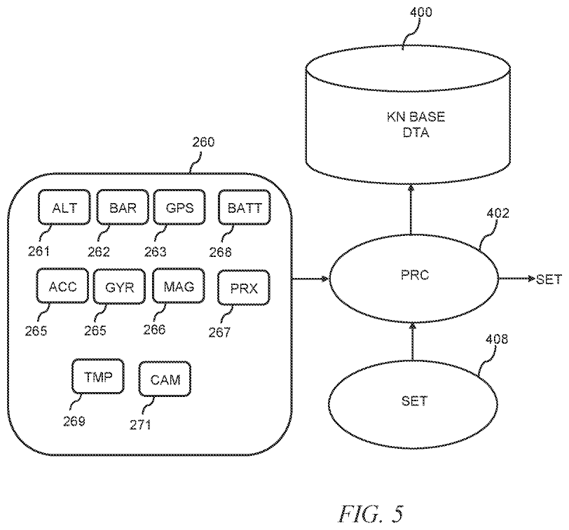

In some embodiments, the remote device is other than a smartphone 100 or further computing power is accessible by the smartphone 100, for example, a neural network 305 for implementing the artificial intelligence engine 402 (see FIGS. 4 and 5).

Referring to FIG. 4, a learning mode of the artificial intelligence engine 402 for the monocopter 200 is shown. As discussed, the control software operates in either the microcontroller 240, the smartphone 100 (or other remote device(s)), a combination of the two, or any of the above in conjunction with other processing devices.

The artificial intelligence engine 402 monitors one or more sensory input devices and input devices (e.g., touch screen interface 92), etc., gathering data during the training and learning mode and storing the data in a knowledgebase 400 (e.g., the knowledgebase is stored in the persistent memory 374 of the smartphone 100). The training and learning mode are anticipated to be executed as an iterative process for a period of time to gather data into the knowledgebase 400 until artificial intelligence engine 402 has sufficient data in the knowledgebase 400 as to reliably operate the main motor 212 and the motors 222/232 for moving the counterweights 220/230 such that the monocopter 200 reliably operates under commands of the user (e.g., touch screen interface 92 inputs on the smartphone 100.

The training and learning mode are carried given a specific hardware configuration of the monocopter 200 as slight variances between each main motor 212, motors 222/232, counterweights 220/230, and other components will change balance parameters of the monocopter 200. For example, a few grams difference due to tolerances between a counterweight 220 of one monocopter 200 and a second monocopter 200 will require learning by the artificial intelligence engine 402 to recognize the slight difference and adjust the knowledgebase 400 for the second monocopter 200, though by starting with the knowledgebase 400 for the first monocopter 200, learning will be quicker.

Referring to FIG. 5, a usage mode of the artificial intelligence engine 402 for the monocopter 200 is shown. The artificial intelligence engine 402 monitors one or more sensory input devices and input devices (e.g., touch screen interface 92), etc., gathering data regarding a current operating mode, orientation, location, and direction of the monocopter 200. Commands and settings 408 such as, initiate takeoff, move east at 5 miles per hour, land, maximum horizontal speed; are fed into the artificial intelligence engine 402 along with data from the sensors 260. Using the knowledgebase 400, the artificial intelligence engine 402 determines settings for the counterweights 220/230 and main motor 212 that will most likely orientate the monocopter 200 at the correct angle and move in the desired direction and speed. The settings are then used to operate the main motor 212 for speed adjustments and the motors 222/232 for moving the counterweights 220/230 such that the monocopter 200 correctly responds to the commands (e.g., takeoff, land). As the artificial intelligence engine 402 constantly monitors data from the sensors 260, data from the sensors 260 constantly updates the knowledgebase 400 to learn from the settings made. For example, if a new, heavier payload is experienced, after the artificial intelligence engine 402 sets the counterweights 220/230 based upon prior knowledge from the knowledgebase 400 and the desired effect is not measured by the sensors 260, the artificial intelligence engine 402 sets the counterweights to correct the skew of the monocopter 200 and also learns that the counterweights 220/230 must be set differently in the future with this specific payload. This learning is then extrapolated to ranges of payloads, then as different payloads are experienced, the artificial intelligence engine 402 makes assumptions based upon this extrapolation and utilizes feedback from the sensors 260 to tune the knowledgebase 400 for accurate operation of the monocopter 200.

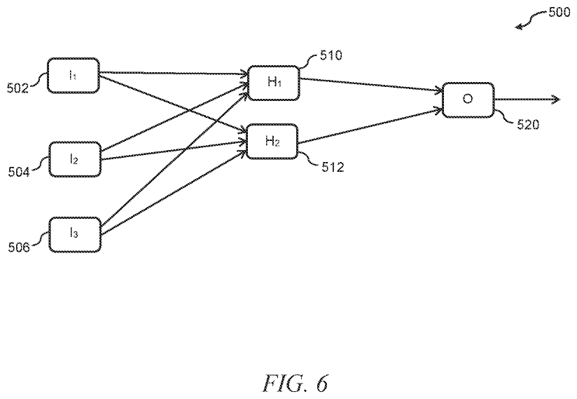

Referring to FIG. 6, an exemplary learning system for the monocopter 200 within which a mathematical process 500 represented by a simplified multilayer feed forward neural network is depicted. During a learning process, iterative sampling of sensory input devices 261/262/263/264/265/266/267/268/269/271 and input devices (e.g., touch screen interface 92), etc., are processed by the neural network in training mode over a period of sufficient duration to, in effect, learn how changes to the power provided to the main motor 212 and positioning of each counterweight 220/230 affect the operation of the monocopter 200. For each iteration, input values are fed into neurons 502/504/506 with adjustments being made to weights and biases of hidden neurons 510 and 512 based on deviations between output value of neuron 520 and a desired output. For example, if a vertical orientation is desired but the sensors 260 indicate the orientation is not vertical, learning takes place as the position of the counterweights 220/230 are changed while monitoring the sensors 260 to “learn” what changes to the counterweights 220/230 will affect the vertical mode of the monocopter 200. The iterative process is repeated using newly captured sensory inputs with continued refinements by use of error function feedbacks being applied to hidden neuron weights and biases. After the multi-iteration cycle the accumulated hidden neuron weights and biases are saved to a knowledgebase 400 as a dataset such that the collection of saved datasets represents learning regarding control of the counterweights 220/230 to affect the desired operation of the monocopter 200. Once sufficient knowledge is obtained and stored in the knowledgebase 400 (sufficient to safely operate the monocopter 200), newly acquired sensory inputs are fed into input neurons 502, 504 and 506 of a neural network that was provisioned with a dataset of weights and biases taken from the knowledgebase 400 and the resulting output from neuron 520 representing a value between 0 and 1 that represents a certain control of the counterweights 220/230.

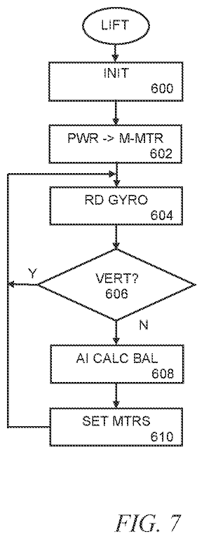

Referring to FIG. 7, a simplified software flowchart is shown. This program flow is an example of how the disclosed system operates based upon a single operation of liftoff. Liftoff starts with the monocopter 200 resting on a surface which is either level or not level. Once the monocopter 200 disconnects from the surface, the monocopter 200 needs to level itself (level is when the axis of the main shaft 214 is perpendicular to a level plane).

Therefore, after initialization 600, sufficient power is provided 602 to the main motor 212 such that sufficient thrust is exerted by the propeller 210 for the monocopter 200 and any associated payload to overcome the force of gravity.

Now a loop begins reading 604 the gyroscope sensors 265 (and any other sensor 260 that is needed) to determine vertical skew. If the monocopter is vertical 606 (e.g., no vertical skew and the main shaft 214 is perpendicular to a level plane), then no adjustment is needed and the loop repeats.

If the monocopter is not vertical 606 (e.g., there is skew as defined by the main shaft 214 not being perpendicular to the level plane), then adjustment is needed. Adjustment is calculated 608 by providing data from the sensors 260 and current command/control status to the artificial intelligence engine that is loaded with the knowledgebase 400. In this example, the current command/control status indicates vertical lift only (no horizontal movement). The data from the sensors provides the artificial intelligence engine with information regarding orientation, movement and direction of the monocopter 200 such that a calculation is performed by the artificial intelligence engine to calculate movements of the counterbalances 220/230 that will move the monocopter 200 towards the desired orientation, movement and direction, then the outputs of the artificial intelligence engine is used to set 610 the motors 222/232 and adjust balance. For example, if the data from the sensors 260 indicate that the monocopter is skewed one degree to the left, then the output of the artificial intelligence engine will be such that the counterbalances 220/230 will be moved by the motors 222/232 to put more mass on an opposite side of the monocopter 200 to impact a vertical orientation.

Note that although it is fully anticipated that the artificial intelligence engine be integrated into the monocopter 200, for example, implemented within the microcontroller 240, for cost, power consumption, and efficiency, the artificial intelligence engine is anticipated to run mostly or completely on a device external to the monocopter 200, for example, the artificial intelligence engine is anticipated to run mostly or completely on the smartphone 100 and/or other external devices.

It is believed that the system and method as described and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A monocopter comprising:
a housing;
a propeller connected to a shaft, the shaft connected to a main motor that is fixed to the housing such that upon operation of the main motor, the shaft rotates and the propeller rotates;
at least two counterweights movably interfaced to the housing;
means for independently moving each of the at least two counterweights; and
means for controlling the main motor and the means for independently moving to enable stable flight of the monocopter.

2. The monocopter of claim 1, wherein the means for independently moving each of the at least two counterweights comprise motors, a shaft of each of the motors interfaced to a respective one of the at least two counterweights at a location that is offset from a center of mass of the respective one of the at least two counterweights.

3. The monocopter of claim 2, wherein an axis of the shaft of at least two of the motors are perpendicular to each other.

4. The monocopter of claim 1, further comprising a processor and sensors, the sensors operatively interfaced to the processor, the processor controls the main motor and the means for independently moving each of the at least two counterweights responsive to data received from the sensors.

5. The monocopter of claim 4, wherein the sensors are selected from a group consisting of a gyroscope sensor, an accelerometer sensor, and an altitude sensor.

6. The monocopter of claim 4, wherein the processor controls the main motor and the means for independently moving each of the at least two counterweights responsive to outputs from an artificial intelligence engine, the artificial intelligence engine takes as input the data received from the sensors.

7. The monocopter of claim 6, wherein the processor connected to a remote device by a wireless data interface and the artificial intelligence engine runs on the remote device whereas the artificial intelligence engine receives the data from the sensors through the wireless data interface and sends the outputs to the processor over the wireless data interface.

8. The monocopter of claim 7, wherein the remote device is a smartphone.

9. The monocopter of claim 2, wherein the motors are servo motors.

10. A method of controlling a monocopter, the method comprising:
receiving command inputs;
reading sensor data to determine at least a pitch of the monocopter;
calculating changes to the pitch of the monocopter required to follow the command inputs by inputting the sensor data and the command inputs into an artificial intelligence engine; and
adjusting two counterweights based upon an output of the artificial intelligence engine.

11. The method of claim 10, wherein each of the two counterweights are interfaced to shafts of a motor and each shaft is interfaced to a respective one of the two counterweights at a location of the respective one of the two counterweights that is distal from a balance point of the respective one of the two counterweights.

12. The method of claim 11, wherein the shafts are perpendicular to each other.

13. The method of claim 10, wherein the sensor data are selected from a group consisting of tilt, acceleration, and altitude.

14. A monocopter comprising:
a housing;
a propeller connected to a shaft, the shaft connected to a main motor that is fixed to the housing such that upon operation of the main motor, the shaft rotates and the propeller rotates;
a first counterweight interfaced to a shaft of a first motor;
the first motor interfaced to the housing;
a second counterweight interfaced to a shaft of a second motor; the second motor interfaced to the housing;
whereas the shaft of the first motor is in a plane that is perpendicular to the shaft of the second motor; and
means for controlling the main motor, the first motor and the second motor to enable stable flight of the monocopter.

15. The monocopter of claim 14, wherein the means for controlling comprises a processor and sensors, the sensors operatively interfaced to the processor, the processor controls the main motor, the first motor and the second motor to independently move each of the first counterweight and second counterwight responsive to data received from the sensors.

16. The monocopter of claim 15, wherein the sensors are selected from a group consisting of a gyroscope sensor, an accelerometer sensor, and an altitude sensor.

17. The monocopter of claim 15, wherein the processor controls the main motor, the first motor, and the second motor responsive to outputs from an artificial intelligence engine, the artificial intelligence engine takes as input the data received from the sensors and command inputs.

18. The monocopter of claim 17, wherein the processor is connected to a remote device by a wireless data interface and the artificial intelligence engine runs on the remote device whereas the artificial intelligence engine receives the data from the sensors through the wireless data interface and sends the outputs to the processor over the wireless data interface.

19. The monocopter of claim 18, wherein the remote device is a smartphone.

20. The monocopter of claim 14, wherein the first motor and the second motor are servo motors.
